(19) United States
(12) Patent Application Publication
(10) Pub. No.: US 2005/0175497 A1
(43) Pub. Date: Aug. 11, 2005

(54) Temperature control method and apparatus and exposure method and apparatus

(75) Inventors: Dai Arai, Kita-ku (JP); Tomoyuki Yoshida, Kumagaya-shi (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 11/066,008

(22) Filed: Feb. 25, 2005

Related U.S. Application Data
(63) Continuation of application No. PCT/JP03/10757, filed on Aug. 26, 2003.

(30) Foreign Application Priority Data
Aug. 29, 2002 (JP) 2002-250179

(51) Int. Cl. G05B 19/43

(52) U.S. Cl. 422/3

(57) ABSTRACT

A temperature control technique and an exposure technique are provided with which high temperature control accuracy can be realized even when a device, which causes thermal fluctuation depending on a temperature-controlled fluid, is used. A gas recovered from a reticle chamber as the temperature control objective, and a high purity purge gas supplied from a gas supply source are mixed in a mixing section. The temperature of the mixed gas is lowered by a refrigerator. Subsequently, the humidity of the gas is measured by a temperature sensor. The gas is then supplied to the reticle chamber via a heating mechanism, a chemical filter which absorbs or generates heat depending on the humidity and a dust protective filter. The heating amount to the gas by the heating mechanism is controlled based on temperature information by a temperature sensor in the reticle chamber and humidity information by the humidity sensor.

### CROSS-REFERENCE

This application is a Continuation Application of International Application No. PCT/JP2003/010757 which was filed on Aug. 26, 2003 claiming the conventional priority of Japanese patent Application No. 2002-250179 filed on Aug. 29, 2002.

### BACKGROUND OF THE INVENTION

1. Field of the Invention

The present invention relates to a temperature control technique for controlling the temperature in a predetermined space. The present invention is preferably usable, for example, when the temperature is controlled in an air-tight or gas-tight room (chamber or the like) in which an exposure apparatus or a part of the mechanism thereof is accommodated, the exposure apparatus or the part of the mechanism thereof being used for the lithography step to produce various devices including, for example, semiconductor elements, image pickup elements (CCD or the like), liquid crystal elements, plasma display elements, and thin film magnetic heads. Further, the present invention relates to an exposure technique and a device production technique based on the use of the temperature control technique.

2. Description of the Related Art

An exposure apparatus is used, for example, when a semiconductor element is produced, in order that a pattern, which is formed on a reticle as a mask, is transferred onto a wafer (or a glass plate or the like) as a substrate to which a photosensitive material is applied. It is necessary for the exposure apparatus to perform the exposure in a state in which the temperature of the environment (atmosphere) for installing the exposure apparatus therein is adjusted within an allowable range with respect to a target temperature, in order that the patterns are transferred highly accurately to the respective layers on the wafer, and the overlay accuracy is maintained to be high between the different layers. Therefore, the exposure apparatus has been hitherto installed in an environmental chamber in which the gas is circulated while the dust and the impurities are removed therefrom and the temperature is controlled highly accurately.

Conventionally, the following operation has been carried out in order to control the temperature in the environmental chamber. That is, the temperature is controlled with a temperature control unit for the gas which is obtained by mixing the gas recovered after the circulation in the environmental chamber and the gas incorporated from the outside. The temperature-controlled gas is supplied into the environmental chamber via a dust protective filter. In this operation, the measured value of the temperature sensor installed in the environmental chamber is subjected to the feedback to the temperature control unit so that the temperature of the gas supplied to the environmental chamber becomes the target temperature.

As described above, in the case of the conventional exposure apparatus, the temperature of the gas has been controlled such that only the measured value, which is supplied from the temperature sensor installed in the environmental chamber, is subjected to the feedback to the temperature control unit irrelevant to the states (for example, the pressure and the humidity) of the gas incorporated from the outside and the gas recovered after the circulation through the environmental chamber.

Recently, it is also demanded to further enhance the dust protective performance in the environmental chamber. In response thereto, those begin to be used include not only the filter (for example, HEPA filter) as the dust protective filter to physically remove fine particulates but also the chemical filter to chemically remove the organic gas or the like. However, if the chemical filter is installed in the flow passage for the gas in a system in which only the measured value of the temperature in the environmental chamber is merely subjected to the feedback to the temperature control unit as in the conventional technique, an inconvenience has arisen such that the temperature of the gas in the environmental chamber tends to be varied, and the temperature control accuracy is lowered.

One of the factors to lower the temperature control accuracy is the fact that the chemical filter causes the heat generation or the heat absorption to a slight extent depending on the increase/decrease in the humidity of the gas which passes through the chemical filter, which has been confirmed by the inventors. In future, it will be also necessary to enhance the control accuracy for the temperature in the environmental chamber as the degree of integration and the fineness of the semiconductor element will be further improved. However, if the chemical filter is used in accordance with the conventional temperature control system, it is feared that any necessary control accuracy cannot be achieved.

Further, when any apparatus such as various sensors other than the chemical filter, which affects the temperature of the gas that makes contact with the apparatus depending on the state of the humidity, the pressure or the like of the gas, is used, it is feared that any necessary temperature control accuracy cannot be obtained in the same manner as described above.

In relation thereto, in order to further increase the resolution, the wavelength of the exposure light beam is being shifted recently from the KrF excimer laser (wavelength: 248 nm) to the ArF excimer laser (wavelength: 193 nm) which is approximately in the vacuum ultraviolet region. The F₂ laser (wavelength: 157 nm), which has the shorter wavelength, is also tried to be used. When the exposure light beam is allowed to have the short wavelength as described above, the absorption is increased by the oxygen in the air and the impurities such as organic gases contained in the air. Therefore, in order to enhance the transmittance with respect to the exposure light beam, it is desirable to supply, to the optical path of the exciting light beam, the gas (hereinafter referred to as “purge gas”) such as the nitrogen gas and the rare gas (helium, neon, argon, krypton, xenon, and radon) from which the impurities are removed to a high extent and which scarcely absorbs the light having the short wavelength. When the purge gas is supplied to the optical path of the exposure light beam, the following system has been also investigated. That is, the optical path of the exposure light beam is divided, for example, into a plurality of gas-tight chambers including, for example, the subchamber for the illumination optical system, the reticle chamber for surrounding the reticle stage system, the space in the projection optical system, and the wafer chamber for surrounding the wafer stage system. The purge gas, which is subjected to the temperature control and from which the impurities are removed to a high extent, is supplied independently to the plurality of gas-tight chambers respectively. Also in the case of the purge gas supply system as described above, when the apparatus such as the chemical filter, which causes the thermal fluctuation depending on the state of the gas, is used, it is necessary to provide a system in which the temperature control can be performed more highly accurately as compared with the system in which merely the temperature in the gas-tight chamber is subjected to the feedback.

### SUMMARY OF THE INVENTION

Taking the foregoing viewpoints into consideration, a first object of the present invention is to provide a temperature control technique and an exposure technique which make it possible to enhance the temperature control accuracy when the temperature is controlled for a predetermined space by using a temperature-controlled gas.

Further, a second object of the present invention is to provide a temperature control technique and an exposure technique which make it possible to obtain a high temperature control accuracy even when an apparatus, which causes the thermal fluctuation depending on the state of a gas, is used, when the temperature-controlled gas is used.

According to the present invention, there is provided a temperature control method for controlling a temperature in a predetermined space by using a gas which is temperature-controlled and which passes through a chemical filter; the temperature control method comprising controlling a temperature of the gas on the basis of information about the temperature in the space and information about at least one or more physical quantities which cause any temperature change of the gas, and supplying the gas to the space; wherein the information about the physical quantity or physical quantities includes information about heat absorption or heat generation in the chemical filter caused by a humidity of the gas to be supplied to the chemical filter.

According to the present invention, when the information about the physical quantity or physical quantities is used, it is possible to postulate the amount of heat release and the amount of heat absorption in the intermediate passage (chemical filter) to supply the gas to the space. When the information about the postulated amount of heat release and the postulated amount of heat absorption and the information about the temperature in the space are used in combination, it is possible to successively set the heating amount or the heat-absorbing amount optimum for the gas in order to maintain the temperature in the space to be, for example, within an allowable range with respect to a target temperature. As a result, the accuracy is improved to control the temperature in the space.

In the present invention, those usable as the information about the physical quantity or physical quantities also include at least one of a pressure and a flow rate of the gas.

It is desirable that the information about the heat absorption or the heat generation in the chemical filter includes the humidity of the gas to be supplied to the chemical filter. For example, when the heat is absorbed if the gas, which passes through the chemical filter, has a high humidity, then the temperature control accuracy is improved in the space by previously increasing the temperature of the gas.

It is desirable that the information about the physical quantity or physical quantities is subjected to feedforward with respect to the temperature control unit in order to control the temperature of the gas to be supplied to the space. When the temperature of the gas is previously adjusted depending on the information about the physical quantity or physical quantities, the amount of temperature fluctuation is decreased in the space.

It is desirable that the information about the temperature in the space is subjected to feedback with respect to the temperature control unit in order to control the temperature of the gas to be supplied to the space. Accordingly, the temperature in the space is set to the target value.

According to another aspect of the present invention, there is provided an exposure method which uses the temperature control method of the present invention; the exposure method comprising controlling, by the temperature control method, a temperature of a space including at least a part of an optical path of an exposure light beam or a space communicated with the space of an exposure apparatus for illuminating a first object with the exposure light beam and exposing a second object with the exposure light beam via the first object. According to the present invention, the temperature control accuracy can be improved for the first object or the second object.

According to still another aspect of the present invention, there is provided a temperature control apparatus for controlling a temperature in a predetermined space by using a gas which is temperature-controlled and which passes through a chemical filter; the temperature control apparatus comprising a gas supply unit which supplies the gas for temperature control to the space; a temperature sensor which detects information about the temperature in the space; a physical quantity sensor which detects information about at least one or more physical quantities which cause temperature change of the gas; and a temperature control unit which controls a temperature of the gas on the basis of results of the detection performed by the temperature sensor and the physical quantity sensor; wherein the information about the physical quantity or physical quantities includes information about heat absorption or heat generation in the chemical filter caused by a humidity of the gas to be supplied to the chemical filter.

According to the present invention, the result of the detection performed by the physical quantity sensor is used together with the result of the detection performed by the temperature sensor, and thus the temperature control accuracy is improved in the space. For example, the temperature in the space can be maintained at the target value highly accurately such that the result of the detection of the temperature sensor is subjected to the feedback with respect to the temperature control unit, and the result of the detection of the physical quantity sensor is subjected to the feedforward with respect to the temperature control unit.

In the present invention, those usable as the information about the physical quantity or physical quantities also include at least one of a pressure and a flow rate of the gas.

It is desirable that the physical quantity sensor detects information about the humidity of the gas to be supplied to the chemical filter. When the information about the humidity is used, the temperature control accuracy is improved.

According to still another aspect of the present invention, there is provided an exposure apparatus for illuminating a first object with an exposure light beam and exposing a second object with the exposure light beam via the first object; the exposure apparatus comprising the temperature control apparatus of the present invention; wherein a temperature of a space including at least a part of an optical path of the exposure light beam or a space communicated with the space is controlled by the temperature control apparatus.

According to the exposure apparatus of the present invention, it is possible to improve the temperature control accuracy for the first object, the second object, or the driving mechanism therefor. Therefore, it is possible to improve the overlay accuracy and the positioning accuracy of the first object or the second object.

According to still another aspect of the present invention, there is provided a method for producing a device, comprising a step of transferring a device pattern formed on a mask as the first object onto a substrate as the second object to effect exposure by using the exposure apparatus of the present invention. When the exposure apparatus of the present invention is used, the overlay accuracy is improved. Therefore, it is possible to mass-produce various devices highly accurately.

### BRIEF DESCRIPTION OF THE DRAWINGS

FIG. 1 schematically shows a structure illustrating an exemplary projection exposure apparatus according to an embodiment of the present invention.

FIG. 2 shows a purge gas supply mechanism shown in FIG. 1.

FIG. 3 shows an example of the temperature control operation performed by using the purge gas supply mechanism shown in FIG. 2.

FIG. 4 shows exemplary steps of producing a device based on the use of the projection exposure apparatus according to the embodiment of the present invention.

### DESCRIPTION OF THE PREFERRED EMBODIMENTS

An explanation will be made below with reference to the drawings about an exemplary preferred embodiment of the present invention.

The present invention is widely applicable, for example, when the temperature is controlled in a clean room in which the lithography system is accommodated, when the temperature is controlled in an environmental chamber in which the entire exposure apparatus is accommodated, and when the optical path of the exposure light beam of the exposure apparatus is divided into a plurality of gas-tight chambers, and the temperature-controlled gas with high transmittance is supplied to the respective gas-tight chambers. In the following embodiment, the explanation will be mage about a case in which the present invention is applied to a projection exposure apparatus based on the step-and-scan system provided with gas-tight chambers to which the temperature-controlled gas is supplied.

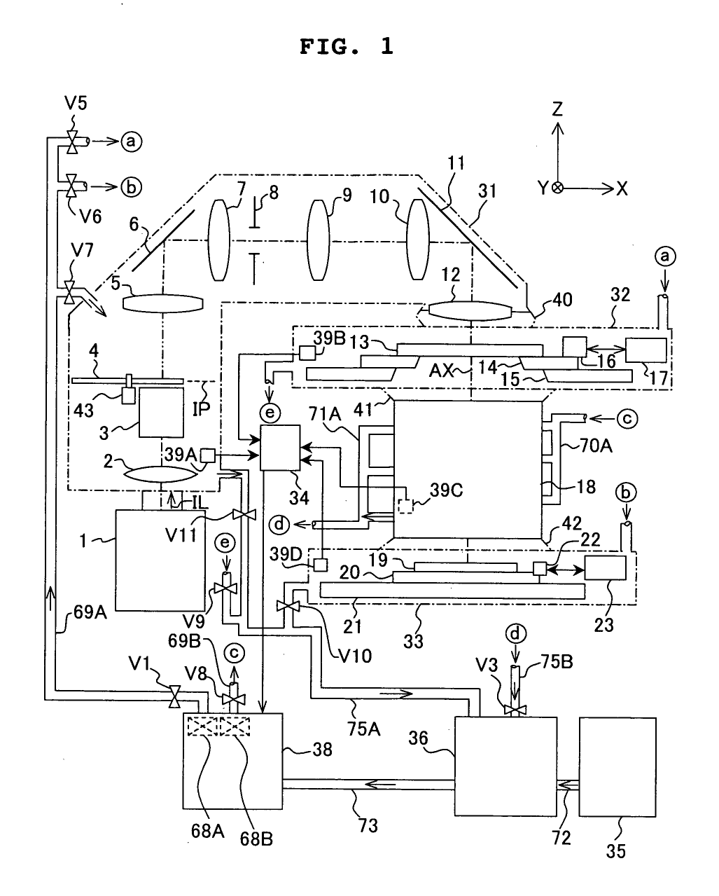

FIG. 1 schematically shows a structure illustrating the projection exposure apparatus according to this embodiment. With reference to FIG. 1, the projection exposure apparatus of this embodiment uses an ArF excimer laser having an oscillation wavelength of 193 nm as an exposure light source 1. The light beam, which can be approximately regarded as the vacuum ultraviolet light as described above, is absorbed by impurities including, for example, oxygen, steam, hydrocarbon gases (for example, carbon dioxide), organic matters, and halides existing in the ordinary atmospheric air. Therefore, in order to avoid the attenuation of the exposure light beam, it is desirable that the concentrations of the impurity gases are suppressed to be low. It is desirable that the gas, which exists in the optical path of the exposure light beam, is exchanged with the gas (hereinafter referred to as “purge gas”) which is chemically stable and which is managed to have low impurity concentrations, such as nitrogen (N₂) gas and rare gas including helium (He), neon (Ne), argon (Ar), krypton (Kr), xenon (Xe), and radon (Rn) as the gas through which the exposure light beam is transmitted. In this embodiment, nitrogen gas is used as the purge gas by way of example.

Those usable as the exposure light beam may include, for example, the F₂ laser beam (wavelength: 157 nm), the Kr₂ laser beam (wavelength: 147 nm), and the Ar₂ laser beam (wavelength: 126 nm). Further, the present invention is also applicable when the KrF excimer laser beam (wavelength: 248 nm) is used as the exposure light beam. Those usable as the exposure light source may also include, for example, the light source which generates the high harmonic wave of the solid laser such as the YAG laser, and the apparatus in which the single wavelength laser in the infrared region or the visible region, which is oscillated, for example, from the DFB semiconductor laser or the fiber laser, is amplified with the fiber amplifier doped with, for example, erbium (Er) (or both of erbium and ytterbium (Yb)), and the wavelength is converted to provide the ultraviolet light beam by using the nonlinear optical crystal.

The nitrogen gas can be used as the gas (purge gas) through which the exposure light beam is transmitted until arrival at a wavelength of about 150 nm even in the vacuum ultraviolet region. However, the nitrogen gas substantially acts as an impurity for the light beam having a wavelength of not more than about 150 nm. Accordingly, it is desirable to use the rare gas as the purge gas for the exposure light beam having the wavelength of not more than about 150 nm. Among the rare gases, it is desirable to use the helium gas in view of, for example, the stability of the refractive index and the high coefficient of thermal conductivity. However, helium is expensive. Therefore, other rare gases may be used when the running cost is regarded to have the priority. The purge gas is not limited to the supply of the gas of the single type. For example, it is also allowable to supply a mixed gas such as a gas obtained by mixing nitrogen and helium at a predetermined ratio.

On the other hand, when the exposure light beam is the KrF excimer laser (wavelength: 248 nm), it is also allowable that the air (so-called dry air), in which the concentrations of impurities such as steam, organic matters, and halides are lowered, is supplied as the purge gas.

The structure of the projection exposure apparatus of this embodiment will be explained in detail below. At first, the exposure light beam (illumination light beam for the exposure) IL, which is composed of the laser beam having a wavelength of 193 nm as the exposure light beam radiated from an exposure light source 1, is shaped for the cross-sectional shape by a shaping optical system 2 included in a first subchamber 31, and the exposure light beam IL comes into a fly's eye lens 3 which serves as an optical integrator (uniformizer or homogenizer) for uniformizing the illuminance distribution. A variable aperture diaphragm 4, which is provided to switch the numerical aperture of the exposure light beam and the aperture shape, for example, into those of the ordinary illumination, the zonal illumination, and the modified illumination, is arranged rotatably by the aid of a driving motor 43 at the pupil plane IP (optical Fourier transformation plane with respect to the pattern plane of the reticle) as the plane disposed on the outgoing side of the fly's eye lens 3.

The exposure light beam IL, which outgoes from the fly's eye lens 3, passes along the variable aperture diaphragm 4, a first relay lens 5, an optical path-bending mirror 6, and a second relay lens 7, and arrives at a field diaphragm (reticle blind) 8. The illumination field is prescribed to be a slender rectangular area. The exposure light beam IL, which has passed through the field diaphragm 8, passes along a first condenser lens 9, a second condenser lens 10, an optical path-bending mirror 11, and a third condenser lens 12, and illuminates a pattern area of the pattern plane (lower surface) of the reticle 13 which serves as a mask. The illumination optical system is constructed, for example, by the exposure light source 1, the shaping optical system 2, the fly's eye lens 3, the variable aperture diaphragm 4, the relay lenses 5, 7, the mirrors 6, 11, the field diaphragm 8, and the condenser lenses 9, 10, 12. The components ranging from the shaping optical system 2 to the condenser lens 12 are accommodated in a subchamber 31 which is a box-shaped gas-tight chamber having the high gas-tightness.

With reference to FIG. 1, the exposure light beam IL, which has transmitted through the reticle 13, forms an image as obtained by reducing the pattern of the reticle 13 by a projection magnification β (β is, for example, ¼ or ⅕) on the wafer 19 as a substrate via a projection optical system 18. The wafer 19 is a disk-shaped substrate composed of, for example, SOI (silicon on insulator) or a semiconductor such as silicon. A photoresist is applied on the wafer 19. The reticle 13 and the wafer 19 of this embodiment correspond to the first object and the second object (substrate subjected to the exposure) of the present invention respectively. The following explanation will be made assuming that the Z axis extends in parallel to the optical axis PAX of the projection optical system 18, the X axis extends in parallel to the sheet surface of FIG. 1 in the plane perpendicular to the Z axis, and the Y axis extends perpendicularly to the sheet surface of FIG. 1. In this case, the illumination area on the reticle 13 is slit-shaped, which is slender in the Y direction. The scanning direction during the exposure for the reticle 13 and the wafer 19 is the X direction.

In this embodiment, the reticle 13 is retained on a reticle stage 14. The reticle stage 14 continuously moves the reticle 13 in the X direction on a reticle base 15, and the reticle stage 14 finely moves the reticle 13 in the X direction, the Y direction, and the rotational direction so that any synchronization error of the reticle 13 is corrected. The position and the angle of rotation of the reticle stage 14 are measured by a movement mirror 16 which is fixed to the end of the reticle stage 14 and an laser interferometer which is included in a reticle stage driving system 17. The reticle stage driving system 17 controls the operation of the reticle stage 14 on the basis of the measured values. The reticle stage system is constructed, for example, by the reticle stage 14 and the reticle base 15. The reticle stage system is accommodated in a reticle chamber 32 which is a box-shaped gas-tight chamber having high gas tightness.

On the other hand, the wafer 19 is retained on a wafer stage 20 by the aid of an unillustrated wafer holder. The wafer stage 20 continuously moves the wafer 19 in the X direction on a wafer base 21, and the wafer stage 20 moves the wafer 19 in the X direction and the Y direction in a stepping manner, if necessary. The position and the angle of rotation of the wafer stage 20 are measured by a movement mirror 22 which is fixed to the end of the wafer stage 20 and a laser interferometer which is included in a wafer stage driving system 23. The wafer stage driving system 23 controls the operation of the wafer stage 20 on the basis of the measured values. The wafer stage 20 controls the focus position and the angle of inclination of the wafer 19 by the autofocus system on the basis of information about the focus position (position in the direction of the optical axis AX) at a plurality of measuring points on the wafer 19 to be measured by an unillustrated autofocus sensor. Accordingly, the surface of the wafer 19 is continuously matched to the image plane of the projection optical system 18 during the exposure. The wafer stage system is constructed, for example, by the wafer stage 20 and the wafer base 21. The wafer stage system is accommodated in a wafer chamber 33 which is a box-shaped gas-tight chamber having high gas tightness.

During the exposure, the following operation is repeated in accordance with the step-and-scan system. That is, when the exposure is completed for one shot area on the wafer 19 under the control of a main control system 24 (see FIG. 2) which manages and controls the operations of the respective parts of the exposure apparatus, then the next shot area is moved to the scanning start position in accordance with the stepping movement of the wafer stage 20, and the reticle stage 14 and the wafer stage 20 are thereafter scanned synchronously in the X direction at the velocity ratio of the projection magnification β of the projection optical system 18, i.e., the reticle stage 14 and the wafer stage 20 are scanned in a state in which the relationship of image formation is maintained between the reticle 13 and the concerning shot area on the wafer 19. Accordingly, the image of the pattern on the reticle 13 is successively transferred to the respective shot areas on the wafer 19.

As described above, the projection exposure apparatus of this embodiment is provided with the purge gas supply mechanism in order that the gas, which is contained in the space including the optical path of the exposure light beam IL, is substituted with the gas (purge gas) through which the exposure light beam IL is transmitted. That is, the part of the illumination optical system, the reticle stage system, and the wafer stage system are accommodated in the subchamber 31, the reticle chamber 32, and the wafer chamber 33 which are the gas-tight chambers respectively. The spaces between the respective optical members of the projection optical system 18 also reside in the lens chambers which are the gas-tight chambers. The high purity purge gas is supplied into the subchamber 31, the reticle chamber 32, and the wafer chamber 33. The high purity purge gas is also supplied into the respective lens chambers in the projection optical system 18.

Further, covers 40, 41, 42, each of which is flexible and each of which is excellent in the gas barrier performance, are provided at the boundary between the subchamber 31 and the upper portion of the reticle chamber 32, the boundary between the lower portion of the reticle chamber 32 and the upper portion of the projection optical system 18, and the boundary between the lower portion of the projection optical system 18 and the upper portion of the wafer chamber 33 respectively. The boundaries are substantially tightly closed by the covers 40 to 42, and the optical path of the exposure light beam is tightly closed approximately completely. Therefore, the optical path of the exposure light beam is hardly contaminated with any gas containing impurities coming from the outside. The amount of attenuation of the exposure light beam is suppressed to be extremely low.

The purge gas supply mechanism of this embodiment includes, for example, a gas supply source 35 such as a gas bomb which accumulates the high purity purge gas, a recovery mixing unit 36 which mixes the purge gas recovered from the respective gas-tight chambers by a suction pump and the high purity purge gas supplied from the gas supply source 35, a gas feed unit 38 which adjusts the temperature of the purge gas to be supplied to the respective gas-tight chambers, and a control unit 34 (see FIG. 2) which is composed of a computer to manage and control the operations of the units as described above. In this embodiment, the nitrogen gas is used as the purge gas. Therefore, for example, a unit or an apparatus can be used as the gas supply source 35 in which high purity nitrogen is liquefied and stored, and nitrogen is gasified and supplied, if necessary.

The recovery mixing unit 36 is operated as follows. That is, the gas, which is contained in the subchamber 31, the reticle chamber 32, and the wafer chamber 33 respectively, is recovered by the aid of a gas discharge tube 75A and gas discharge tubes equipped with valves V11, V9, V10 in accordance with the gas flow control based on the substantially steady flow at a pressure in the vicinity of the atmospheric pressure. Further, the gas, which is contained in the plurality of lens chambers of the projection optical system 18, is recovered by the aid of a plurality of branched gas discharge tubes 71A, a gas discharge tube 75B, and a valve V3 in accordance with the gas flow control. In the case of the gas flow control, the purge gas, which has approximately the same flow rate as the flow rate of the gas discharged from the respective gas-tight chambers, is supplied to the respective gas-tight chambers.

On the other hand, the gas feed unit 38 is provided with filter sections 68A, 68B including a dust protective filter for removing fine particulates such as HEPA filter (high efficiency particulate air-filter) and ULPA filter (ultra low penetration air-filter), and a chemical filter for removing chemical impurities such as ammonia and organic gases. When the temperature-controlled purge gas (details will be described later on) passes through the filter sections 68A, 68B, the impurities including fine particulates are removed. The purge gas, which has passed through the filter section 68A, is supplied to the subchamber 31, the reticle chamber 32, and the wafer chamber 33 via a gas feed tube 69A equipped with a valve V1 and branched gas feed tubes equipped with valves V7, V5, V6 respectively. The purge gas, which has passed through the filter section 68B, is supplied to the plurality of lens chambers in the projection optical system 18 via a gas feed tube 69B equipped with a valve V8 and a gas feed tube 70A equipped with a plurality of branched tubes. In this embodiment, the valves V1 to V11 are electromagnetically openable/closable valves respectively. The opening/closing operations thereof are controlled by the control unit 34 (see FIG. 2) mutually independently. The control unit 34 can control not only the opening/closing of the valve but also the size (throttle amount of the valve) of the valve diameter. When the size of the valve diameter is controlled, it is possible to control not only the supply/cut off of the purge gas but also the supply amount of the purge gas (flow rate per time).

The temperature-controlled purge gas can be fed in accordance with the gas flow control system at any desired flow rate to any one of the gas-tight chambers of the interiors of the subchamber 31, the reticle chamber 32, the wafer chamber 33, and the plurality of lens chambers in the projection optical system 18 on the basis of the operation to recover the gas by the recovery mixing unit 36, the operation to supply the purge gas from the gas feed unit 38, the opening/closing operations of the valves V1, V5 to V8, and the size of the valve diameter thereof. The gas, which is contained in the plurality of lens chambers of the projection optical system 18, may be discharged in a stepwise manner in accordance with a suction system involved with the reduction of the pressure to obtain a degree of vacuum to some extent.

Temperature sensors 39A to 39D are installed in the subchamber 31, the reticle chamber 32, the projection optical system 18, and the wafer chamber 33 in order to detect the temperatures of the purge gas therein respectively. The temperature information about each of the gas-tight chambers is continuously measured at a predetermined sampling rate by the temperature sensors 39A to 39D. The measurement data is supplied to the control unit 34 shown in FIG. 2. In this embodiment, the purge gas is supplied to the respective gas-tight chambers so that the temperatures of the purge gas in the respective gas-tight chambers measured by the temperature sensors 39A to 39D are included in a predetermined allowable range (for example, ±0.01 to 0.001 deg.) with respect to a predetermined target temperature (for example, 23° C.).

An explanation will be made below with reference to FIG. 2 about the detailed system concerning the temperature control of the purge gas supply mechanism of this embodiment. However, in FIG. 2, only the reticle chamber 32 of the plurality of gas-tight chambers is illustrated, and the pipings not communicated with the reticle chamber 32 as well as the valves and the branched pipings are omitted from the illustration for the purpose of convenient explanation.

With reference to FIG. 2, the control unit 34 controls the operations of the respective parts under the control of the main control system 24 which manages and controls the operation of the entire exposure apparatus. In the recovery mixing unit 36, the gas recovered by the suction as described above and the high purity purge gas supplied from the gas supply source 35 via a piping 72 are mixed with each other in a mixing section 45 (provided with a suction pump). The mixed gas is supplied via a piping 46A to a refrigerator 47 in which the temperature is once lowered. The mixing section 45 is provided with a suction pump which sucks the gas from the gas discharge tube 75A, and a gas feed fan which feeds the mixed gas via the piping 46A. The gas supply source 35, the gas discharge tube 75A for recovering the gas, and the mixing section 45 correspond to the “gas supply unit” of the present invention. However, the present invention is also applicable to a system in which the gas (fluid) circulated in a gas-tight chamber (predetermined space) is not reused.

Assuming that the target temperature in the reticle chamber 32 as the gas-tight chamber as the temperature control objective is 23° C., the temperature of the mixed gas is lowered by the refrigerator 47, for example, to 20° C. which is lower than the above by several degrees. The gas, which has passed through the refrigerator 47, is supplied via a piping 46B to a measuring section which measures information about the physical quantities (flow rate, temperature, humidity, and pressure in this embodiment) which possibly cause the temperature change of the purge gas in the reticle chamber 32.

The measuring section includes a flow rate meter 48 which measures the flow rate of the gas in the piping 46B, a piping 73 which is installed between the flow rate meter 48 and the gas feed unit 38, and a sensor section which is composed of a humidity sensor 49, a temperature sensor 50, and a pressure sensor 51 installed at the inside of the piping 73. The information about the flow rate measured by the flow rate meter 48 and the information about the humidity, the temperature, and the pressure (gas pressure) of the gas flowing through the piping 73 measured by the humidity sensor 49, the temperature sensor 50, and the pressure sensor 51 are supplied to the control unit 34 at a predetermined sampling rate respectively.

The gas, for which the information about the physical quantities has been measured, is supplied via the piping 73 to the gas feed unit 38. In the gas feed unit 38, the gas, which has been supplied via the piping 73, is heated to a predetermined temperature by a heating mechanism 52 including a heater. The heated gas passes through a piping 46C, the chemical filter 53 for removing chemical impurities such as ammonia and organic gases, and the dust protective filter 54. The heated gas is supplied as the temperature-controlled high purity purge gas to the gas feed tube 69A. The chemical filter 53 and the dust protective filter 54 correspond to the filter section 68A shown in FIG. 1. The purge gas, which has been supplied to the gas feed tube 69A, is supplied into the reticle chamber 32. The temperature information, which is measured by the temperature sensor 39B in the reticle chamber 32, is also supplied to the control unit 34.

The heating mechanism 52 corresponds to the “temperature control unit” of the present invention. In this embodiment, the temperature of the gas is once lowered by the refrigerator 47, and then the gas is heated by the heating mechanism 52 to the target temperature. Therefore, it is possible to obtain the high response speed and the high temperature control accuracy by the relatively simple control in which only the heating amount is controlled. The refrigerator 47 may be omitted, and a temperature control unit, which can perform both of the heating and the heat absorption, may be provided in place of the heating mechanism 52. In the case of this system, the mechanism can be simplified, although the temperature control is complicated.

The substances, which are removed by the chemical filter 53, also include, for example, the substance which adheres to the optical element used for the projection exposure apparatus and which causes the cloudiness thereof, the substance which floats in the optical path of the exposure light beam and which varies, for example, the transmittance (brightness) or the illuminance distribution of the illumination optical system and/or the projection optical system, and the substance which adheres to the surface of the wafer (photoresist) and which deforms the pattern image after the development process. Those usable as the chemical filter 53 include an activated carbon filter (for example, GIGASORB (trade name) produced by NITTA CORPORATION is usable), a filter based on the ion exchange membrane system (for example, EPIX filter (trade name) produced by Ebara Corporation is usable), a zeolite filter, and a filter obtained by combining these filters. The chemical filter as described above also removes siloxane (substance principally composed of Si—O chain) and silazane (substance principally composed of Si—N chain).

In this embodiment, the control unit 34 controls the heating amount S per unit time for the gas in the heating mechanism 52 so that the temperature in the reticle chamber 32 is included within the allowable range with respect to the target temperature (=TC) as described above, on the basis of the information about the temperature T of the purge gas measured by the temperature sensor 39B in the reticle chamber 32 and the information about the flow rate F, the humidity H, the temperature U, and the pressure P of the gas measured by the flow rate meter 48, the humidity sensor 49, the temperature sensor 50, and the pressure sensor 51 in the recovery mixing unit 36. In this case, the reticle chamber 32 is arranged on the downstream side of the gas with respect to the heating mechanism 52. Therefore, the information about the temperature T, which is measured by the temperature sensor 39B in the reticle chamber 32, is subjected to the feedback to the heating mechanism 52. On the other hand, the recovery mixing unit 36 (measuring unit for the physical quantities) is arranged on the upstream side of the gas with respect to the heating mechanism 52. Therefore, the information about the flow rate F, the humidity H, the temperature U, and the pressure P of the gas, which is measured by the flow rate meter 48, the humidity sensor 49, the temperature sensor 50, and the pressure sensor 51 of the measuring section, is subjected to the feedforward to the heating mechanism 52.

That is, in order to effect the feedback for the temperature T of the temperature sensor 39B, the following assumption is made by way of example provided that ΔT (=T−TC) represents the difference between the target temperature TC in the reticle chamber 32 and the temperature T. The coefficients to determine the amount of change of the heating amount S per unit time in the heating mechanism 52 from the difference itself, the integral of the difference for a predetermined integral time Δt (actually the sum of digital data, the followings are the same) ΔTdt, and the differential of the difference (actually the difference of digital data, the followings are the same) dΔT/dt are designated as kT1, kT2, and kT3 respectively. The coefficients are experimentally determined beforehand corresponding to, for example, the level of the allowable range with respect to the target temperature in the reticle chamber 32, and the coefficients are stored in the main control system 24. The coefficients are set by the control unit 34 under the main control system 24 before the start of the exposure step. The control unit 34 determines the amount of change ΔS1 of the heating amount S in the heating mechanism 52 caused by the temperature T of the temperature sensor 39B in accordance with the following expression.
ΔS1=kT1·ΔT+kT2·ΔTdt+kT3·dΔT/dt (1)

Subsequently, in order to effect the feedforward for the flow rate F, the humidity H, the temperature U, and the pressure P of the gas measured by the flow rate meter 48, the humidity sensor 49, the temperature sensor 50, and the pressure sensor 51, the reference values (for example, average values of actually measured values in a certain exposure step) of the physical quantities are previously designated as FC, HC, UC, and PC respectively by way of example. For the purpose of simplification, the differences between the reference values and the measured values are designated as ΔF (=F−FC), ΔH (=H−HC), ΔU (=U−UC), and ΔP (=P−PC) respectively. The coefficients, which are used to determine the amount of change of the heating amount S in the heating mechanism 52 from the differences, are designated as kF1, kH1, kU1, and kP1 respectively. The coefficients are previously set by the control unit 34 under the main control system 24 as well. The coefficients are also experimentally determined beforehand corresponding to, for example, the level of the allowable range with respect to the target temperature in the reticle chamber 32, and are stored in the main control system 24. The coefficients are set by the control unit 34 under the main control system 24 before the start of the exposure step. The control unit 34 determines the amount of change ΔS2 of the heating amount S in the heating mechanism 52 caused by the flow rate F, the humidity H, the temperature U, and the pressure P of the gas in accordance with the following expression.
ΔS2=kF1·ΔF+kH1·ΔH+kU1·ΔU+kP1·ΔP (2)

In this embodiment, as shown in FIG. 2, the chemical filter 53 is arranged between the heating mechanism 52 (temperature control unit) and the reticle chamber 32 (gas-tight chamber). The chemical filter 53 has such a tendency that the heat absorption occurs when the humidity of the gas passing through the inside is increased, and the temperature of the gas to be discharged is lowered. Further, the chemical filter 53 has such a tendency that the heat generation occurs when the humidity of the gas passing through the inside is lowered, and the temperature of the gas to be discharged is increased. The reason thereof is that the chemical filter 53 acts so that the humidity at the inside is maintained to be a certain constant humidity. Accordingly, in this embodiment, the value of the coefficient kH1 is set to a predetermined positive value so that the amount of change ΔS2 of the heating amount is “+” when the difference ΔH (=H−HC) of the humidity H measured by the humidity sensor 49 from the reference value HC is “+”, and the amount of change ΔS2 is “−” when the difference ΔH is “−”. In this case, for example, the humidity, at which the heat absorption or the heat generation is caused in the chemical filter 53, may be experimentally measured beforehand, and the humidity may be used as the reference value HC.

The reference value HC is individually determined beforehand depending on the types of the chemical filter 53 to be used respectively (for example, the structure and the material of the chemical filter) so that the reference value HC is used properly for each of the individual cases depending on the filter to be used. When the abilities of the heat absorption and the heat generation of the chemical filter to be used are varied in the time-dependent manner, it is preferable that the reference value HC is also varied depending on the change of the ability.

In order to determine the amount of change ΔS2 of the heating amount S more strictly, it is also allowable that the amount of change ΔS2 is determined by using a form of linear function or higher order function in relation to the difference ΔH. Further, the amount of change ΔS2 may be determined considering the integral ΔHdt of the difference ΔH for the predetermined integral time Δt and the differential dΔT/dt of the difference as well. As for the other parameters of the flow rate F, the temperature U, and the pressure P, the amount of change of the heating amount S may be also determined considering not only the difference value but also the integral value and the differential value in order to further enhance the control accuracy.

When the flow rate F is increased, the heating amount S may be increased beforehand, because the temperature is lowered if the same heating amount is used. Accordingly, the value of the coefficient kF1 to determine the amount of change of the heating amount S with respect to the flow rate F may be a predetermined positive value (for example, experimentally determined). On the other hand, when the temperature U is high, it is enough that the heating amount S is small. Therefore, the coefficient kU1 may be a predetermined negative value.

As described above, in this embodiment, the flow rate F, the humidity H, the temperature U, and the pressure P of the gas are measured. Therefore, the enthalpy (unit: energy (J or cal)), which is the energy quantity of state of the gas, can be determined from the quantities of state as described above. In this process, when the heating value of steam, which relates to the passage ranging from the humidity sensor 49 to the reticle chamber 32, is previously measured, the amount of change ΔS2 of the heating amount S in the heating mechanism 52 may be set so that the amount of the heating value of steam is corrected.

The temperature control unit 34 shown in FIG. 2 adds the amounts of change ΔS1, ΔS2 of the heating amount S in the expressions (1) and (2) in accordance with the following expression to calculate the amount of change ΔS of the heating amount S in the heating mechanism 52.
ΔS=ΔS1+ΔS2 (3)

The temperature control unit 32 sends the control signal to the heating mechanism 52 so that the heating amount S is changed by the amount of change ΔS. The calculations of the expressions (1) to (3) and the supply of the control signal of the change of the heating amount S to the heating mechanism 52 are continuously performed at a predetermined sampling rate (for example, about several tens Hz to several kHz) during the exposure step.

Accordingly, the temperature of the purge gas in the reticle chamber 32 is included in the allowable range with respect to the target temperature as described above. Thus, it is possible to perform the exposure highly accurately.

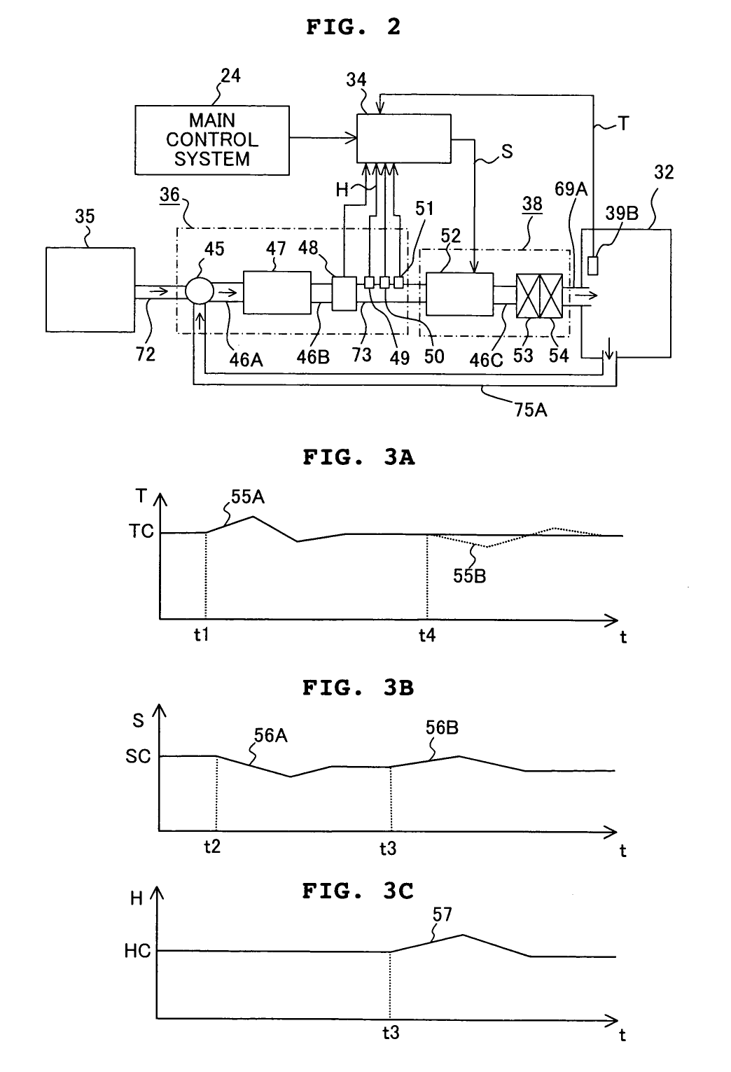

Specifically, FIGS. 3A, 3B, and 3C show examples of the changes of the temperature T (measured value obtained by the temperature sensor 39B) in the reticle chamber 32 shown in FIG. 2, the heating amount S in the heating mechanism 52, and the humidity S measured by the humidity sensor 49 respectively. The horizontal axes in FIGS. 3A to 3C represent the elapsed time t. For example, as shown by a solid line 55A in FIG. 3A, when the temperature T in the reticle chamber 32 is shifted from the target value TC at a time t1, then the heating amount S of the heating mechanism 52 is shifted from the reference value SC from a time t2 just thereafter as shown by a solid line 56A in FIG. 3B by effecting the feedback of the temperature T, and the temperature T is returned to the target value TC.

On the other hand, as shown by a solid line 57 in FIG. 3C, when the humidity H, which is measured by the humidity sensor 49, is varied from the reference value HC from a time t3, then the variation is subjected to the feedforward so that the heat absorption/generation in the chemical filter 58 is offset, and the heating amount S of the heating mechanism 52 is changed as shown in FIG. 3B. Accordingly, the temperature T in the reticle chamber 32 is maintained to be the target value TC. On the contrary, if the feedforward is not effected for the humidity H, the temperature T in the reticle chamber 32 is varied by the heat absorption/generation in the chemical filter 53 as shown by a dotted line 55B in FIG. 3A. The variation is gradually decreased by the feedback of the temperature T. However, the temperature control accuracy is deteriorated.

As described above, in this embodiment, the heating amount S in the heating mechanism 52 is controlled so that the heat absorption/generation in the chemical filter 53 installed next to the heating mechanism 52 is offset on the basis of the humidity H of the gas measured before the heating mechanism 52. Therefore, even when the chemical filter 53 is used, then the amount of fluctuation or variation of the temperature is suppressed in the reticle chamber 32, and it is possible to obtain the high temperature control accuracy. Further, the heating amount S in the heating mechanism 52 is also controlled by using the flow rate F, the temperature U, and the pressure P of the gas measured before the heating mechanism 52. Therefore, it is possible to obtain the higher temperature control accuracy.

Further, in this embodiment, the measured humidity H is subjected to the feedforward to the heating mechanism 52. Therefore, the influence of the chemical filter 53 can be offset before the temperature fluctuation occurs in the reticle chamber 32. Therefore, it is possible to obtain the higher temperature control accuracy.

In the exemplary embodiment shown in FIG. 2, the humidity H of the gas is measured in the recovery mixing unit 36 disposed at the upstream stage with respect to the heating mechanism 52. However, the humidity H may be measured in the chemical filter 53. In this case, the measured value of the humidity H is subjected to the feedback to the heating mechanism 52. However, even in this case, the heating amount of the heating mechanism 52 can be controlled on the basis of the measured value obtained before the reticle chamber 32. Therefore, the temperature control accuracy in the reticle chamber 32 is improved as compared with a case in which the value of the humidity H is not considered.

In the exemplary embodiment shown in FIG. 2, if the flow rate F and the pressure P of the gas, which are measured in the recovery mixing unit 36, can be regarded to be approximately constant values, or if the amount of heat fluctuation in the reticle chamber 32, which is caused by the flow rate F and the pressure P of the gas, is within an allowable range, then it is not necessarily indispensable that the values of the flow rate F and the pressure P of the gas are used to control the heating mechanism 52.

In FIG. 1, the supply of the purge gas to the projection optical system 18 and the three gas-tight chambers including the subchamber 31, the reticle chamber 32, and the wafer chamber 33 is performed by commonly using the purge gas supply mechanism as shown in FIG. 2 while controlling the valves. However, the purge gas supply mechanism as shown in FIG. 2 may be provided independently for each of the gas-tight chambers and the projection optical system. When the purge gas supply mechanisms are provided for the respective supply destinations, then the temperature of the purge gas to be supplied can be independently controlled for each of the supply destinations, and/or the temperature control accuracy (for example, the control accuracy is either ±0.1° or ±0.01°) can be also set independently for each of the supply destinations.

In the purge gas supply mechanism of this embodiment, oxygen concentration sensors (not shown), which detect the concentrations of oxygen gas in impurities at the inside, are installed in the subchamber 31, the reticle chamber 32, the projection optical system 18, and the wafer chamber 33 respectively. The information about the oxygen concentration as the impurity in each of the gas-tight chambers is continuously measured at a predetermined sampling rate. The measured data is also supplied to the control unit 34 shown in FIG. 2. In this embodiment, concurrent to the temperature control as described above, if the oxygen gas having a concentration of not less than a predetermined allowable concentration is detected by any one of the oxygen concentration sensors, the ratio of the high purity purge gas supplied from the gas supply source 35 is increased in the mixed gas to be supplied to the gas-tight chamber in which the oxygen gas is detected until the oxygen gas concentration is not more than the allowable concentration in accordance with the instruction from the control unit 34 shown in FIG. 2. Those usable as the oxygen concentration sensor include, for example, an oxygen concentration meter based on the polarograph system, an oxygen concentration meter based on the zirconia system, and an oxygen sensor based on the yellow phosphorous light emission system. Those usable as the sensor for detecting the impurity also include sensors for detecting, for example, ozone (O₃), steam, and hydrocarbon molecules such as carbon dioxide (CO₂) other than the oxygen concentration sensor.

When the present invention is applied, for example, to the temperature control for a clean room (gas-tight chamber) in which the lithography system is installed, the gas, which is to be supplied to the clean room, is, for example, the air (dry air) obtained by incorporating the outside air via a dust protective filter or the like followed by being dried. Similarly, when the present invention is applied, for example, to the temperature control for an environmental chamber (gas-tight chamber) in which the exposure apparatus is accommodated as a whole, the gas, which is to be supplied to the environmental chamber, is the air (dry air) obtained by incorporating the air via a dust protective filter or the like in the clean room.

In the respective embodiments as described above, the present invention is applied to the projection exposure apparatus based on the step-and-scan system. However, the present invention is also applicable to a projection exposure apparatus of the full field exposure type such as a stepper. The magnification of the projection optical system provided for the projection exposure apparatus as described above is not limited to those of reduction, which may be those of 1× or magnification. The present invention is also applicable, for example, to a liquid immersion type exposure apparatus disclosed in the pamphlet of International Publication No. 99/49504. The present invention is also applicable, for example, to an exposure apparatus provided with two wafer stages in which the exposure operation and the alignment operation (mark-detecting operation) can be performed substantially concurrently, as disclosed in the pamphlets of International Publication Nos. 98/24115 and 98/40791. It is clear that the present invention is also applicable, for example, to an exposure apparatus based on the proximity system in which no projection optical system is used.

The illumination optical system and the projection optical system of the embodiment described above are assembled such that the respective optical members are arranged in the support member and the body tube in the predetermined positional relationship to perform the adjustment, and then the support member and the body tube are installed to the unillustrated column. Together with the assembling and the adjustment, the assembling and the adjustment are performed, for example, for the stage system, the laser interferometer, and the purge gas supply mechanism for purging the interior of the apparatus, and the respective constitutive elements are connected electrically, mechanically, and/or optically. Thus, the projection exposure apparatus of the embodiment as described above is assembled. In this case, it is desirable that the operation is performed in a clean room in which the temperature is managed.

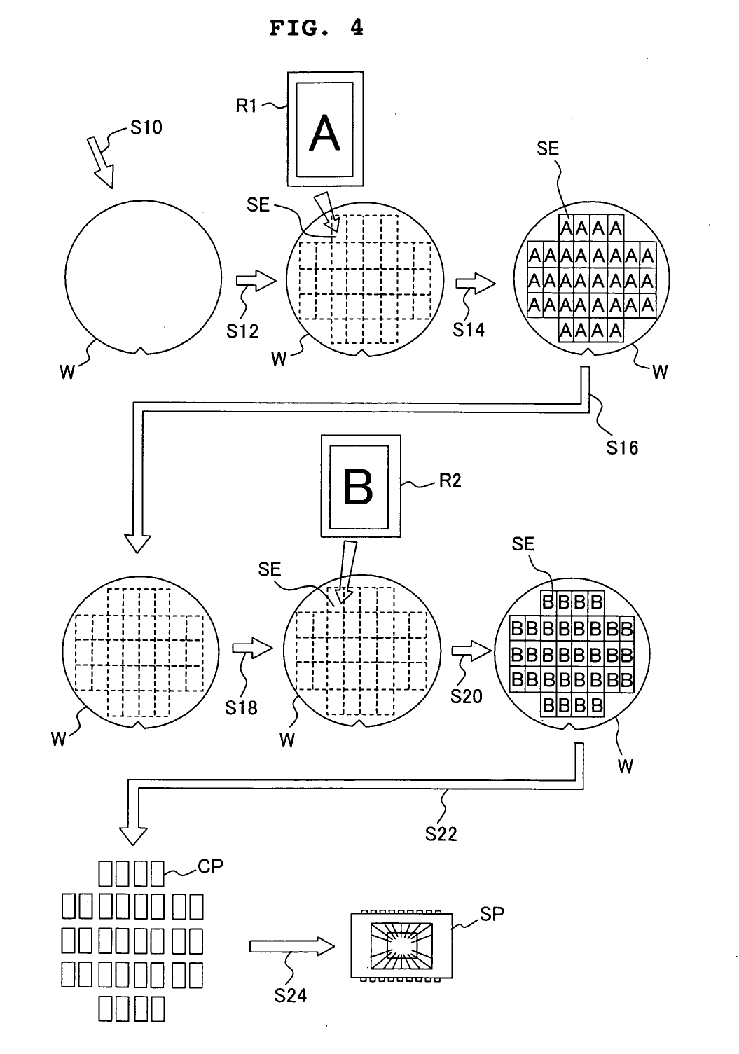

Next, an explanation will be made with reference to FIG. 4 about exemplary steps of producing a semiconductor device based on the use of the projection exposure apparatus of the embodiment described above.

FIG. 4 shows the exemplary steps of producing the semiconductor device. With reference to FIG. 4, the wafer W is firstly produced, for example, from a silicon semiconductor. After that, the photoresist is applied onto the wafer W (Step S10). In the next Step S12, the reticle (temporarily referred to as “R1”) is loaded on the reticle stage of the projection exposure apparatus of the embodiment described above (FIG. 1). The pattern (indicated by the symbol A) of the reticle R1 is transferred (subjected to the exposure) to all shot areas SE on the wafer W in accordance with the scanning exposure system. During this process, the double exposure is performed, if necessary. The wafer W is, for example, a wafer having a diameter of 300 mm (12-inch wafer). For example, the size of the shot area SE resides in such a rectangular area that the width in the non-scanning direction is 25 mm, and the width in the scanning direction is 33 mm. Subsequently, the development, the etching, and the ion implantation are performed in Step S14. Accordingly, the predetermined pattern is formed in each of the shot areas SE on the wafer W.

Subsequently, the photoresist is applied onto the wafer W in Step S16. After that, in Step S18, the reticle (temporarily referred to as “R2”) is loaded on the reticle stage of the projection exposure apparatus of the embodiment described above (FIG. 1). The pattern of the reticle R2 (indicated by the symbol B) is transferred (subjected to the exposure) to the respective shot areas SE on the wafer W in accordance with the scanning exposure system. In Step S20, for example, the development of the wafer W, the etching, and the ion implantation are performed. Accordingly, the predetermined pattern is formed on each of the shot areas on the wafer W.

The operation, which ranges from the exposure step to the pattern formation step (Step S16 to Step S20) described above, is repeated by a number of times required to produce the desired semiconductor device. Further, the dicing step (Step S22) for cutting and separating the respective chips CP on the wafer W one by one, the bonding step, and the packaging step (Step S24) are performed. Thus, the semiconductor device SP as the product is produced.

According to the method for producing the device of the present invention, it is possible to improve the temperature control accuracy of the projection exposure apparatus for the reticle and the wafer. Therefore, it is possible to improve, for example, the overlay accuracy. It is possible to produce, at a high yield, the semiconductor device (integrated circuit) which is more highly integrated and which has high performance.

The way of use of the exposure apparatus of the present invention is not limited to the exposure apparatus for producing the semiconductor device. The present invention is also applicable, for example, to the exposure apparatuses for producing liquid crystal display devices formed on rectangular glass plates and display devices such as plasma displays as well as to the exposure apparatuses for producing various devices including, for example, image pickup elements (for example, CCD), micromachines, thin film magnetic heads, and DNA chips. Further, the present invention is also applicable to the exposure step (exposure apparatus) when masks (for example, photomasks and reticles) formed with mask patterns of various devices are produced by using the photolithography step.

The present invention is not limited to the embodiments described above, which may be variously constructed within a range without deviating from the gist or essential characteristics of the present invention. All of the contents of the disclosure of Japanese Patent Application No. 2002-250179 filed on Aug. 29, 2002, which include the specification, claims, drawings, and abstract, are cited exactly as they are and incorporated into this application by reference.

According to the present invention, the temperature of the fluid for the temperature control is controlled on the basis of the information about at least one or more physical quantities which cause the temperature change of the fluid. Therefore, it is possible to improve the temperature control accuracy, for example, in the space to which the fluid is supplied, for example, in the chamber for accommodating the exposure apparatus. Therefore, when the present invention is applied to the exposure method and the exposure apparatus, it is possible to improve the temperature control accuracy for the first object (mask) and the second object (substrate) during the exposure. Therefore, it is possible to highly accurately produce the highly functional device.

According to the present invention, for example, when the apparatus such as the chemical filter, which causes the thermal fluctuation depending on the humidity of the gas as the fluid, is used, it is possible to obtain the high temperature control accuracy by controlling the temperature by using the information obtained by measuring the humidity.

Further, the amount of heat absorption/generation is controlled in the temperature control unit by effecting the feedback for information about the temperature in the space as the control objective and effecting the feedforward for the information about the physical quantities. Thus, it is possible the set the temperature in the space to the target value at a high speed with a high control accuracy.

1. A temperature control method for controlling a temperature in a predetermined space by using a gas which is temperature-controlled and which passes through a chemical filter, the temperature control method comprising:
controlling a temperature of the gas on the basis of information about the temperature in the space and information about at least one or more physical quantities which cause any temperature change of the gas, and supplying the gas to the space,
wherein the information about the physical quantity or physical quantities includes information about heat absorption or heat generation in the chemical filter caused by a humidity of the gas to be supplied to the chemical filter.

2. The temperature control method according to claim 1, wherein the information about the physical quantity or physical quantities further includes at least one of a pressure and a flow rate of the gas.

3. The temperature control method according to claim 1, wherein the information about the heat absorption or the heat generation in the chemical filter includes the humidity of the gas.

4. The temperature control method according to claim 1, wherein the information about the physical quantity or physical quantities is subjected to feedforward in order to control the temperature of the gas to be supplied to the space.

5. The temperature control method according to claim 1, wherein the information about the temperature in the space is subjected to feedback in order to control the temperature of the gas to be supplied to the space.

6. An exposure method which uses the temperature control method as defined in claim 1, the exposure method comprising:
controlling, by the temperature control method, a temperature of a space including at least a part of an optical path of an exposure light beam or a space communicated with the space of an exposure apparatus for illuminating a first object with the exposure light beam and exposing a second object with the exposure light beam via the first object.

7. A temperature control apparatus for controlling a temperature in a predetermined space by using a gas which is temperature-controlled and which passes through a chemical filter, the temperature control apparatus comprising:
a gas supply unit which supplies the gas for temperature control to the space;
a temperature sensor which detects information about the temperature in the space;
a physical quantity sensor which detects information about at least one or more physical quantities which cause temperature change of the gas; and
a temperature control unit which controls a temperature of the gas on the basis of results of the detection performed by the temperature sensor and the physical quantity sensor,
wherein the information about the physical quantity or physical quantities includes information about heat absorption or heat generation in the chemical filter caused by a humidity of the gas to be supplied to the chemical filter.

8. The temperature control apparatus according to claim 7, wherein the information about the physical quantity or physical quantities further includes at least one of a pressure and a flow rate of the gas.

9. The temperature control apparatus according to claim 7, wherein the physical quantity sensor detects the humidity of the gas.

10. The temperature control apparatus according to claim 7, wherein the information about the physical quantity or physical quantities supplied from the physical quantity sensor is subjected to feedforward to the temperature control unit, and the information about the temperature in the space supplied from the temperature sensor is subjected to feedback to the temperature control unit.

11. An exposure apparatus for illuminating a first object with an exposure light beam and exposing a second object with the exposure light beam via the first object, the exposure apparatus comprising:
the temperature control apparatus as defined in claim 7, wherein:
a temperature of a space including at least a part of an optical path of the exposure light beam or a space communicated with the space is controlled by the temperature control apparatus.

12. A method for producing a device, comprising a step of transferring a device pattern formed on a mask as the first object onto a substrate as the second object to effect exposure by using the exposure apparatus as defined in claim 11.
